(19) United States
(12) Patent Application Publication
(10) Pub. No.: US 2004/0027828 A1
(43) Pub. Date: Feb. 12, 2004

(54) Indication apparatus using beam

(75) Inventor: Yoshihiko Awa, Sapporo-shi (JP)

Correspondence Address: REED SMITH LLP, 3110 Fairview Park Drive, Suite 1400, Falls Church, VA, 22042, US

(73) Assignee: Hokutech Co., Ltd

(21) Appl. No.: 10/173,652

(22) Filed: Jun. 19, 2002

(51) Int. Cl. F21K 2/00

(52) U.S. Cl. 362/259

(57) ABSTRACT

There is provided an indication apparatus of a safety facility that can make a clear distinction between a sidewalk and a driveway by using a beam going straight on, and that can make drivers certainly recognize the existence of a pedestrian crossing when it is used in the pedestrian crossing. The indication apparatus includes a light emitting system capable of emitting a beam that goes straight on, at all times or arbitrarily; and a support capable of fixing the light emitting system vertically or in an arbitrary position.

### BACKGROUND OF THE INVENTION

1. Field of the Invention

The present invention relates mainly to means for clearly indicating existence of a road shoulder in a road, a road division such as a pedestrian crossing, and other safety facilities. In particular, the present invention relates to an indication apparatus using a beam emitting system, which serves as indication means capable of being used as, for example, a fish-luring light.

2. Description of the Related Art

As conventional devices for making a distinction between a sidewalk and a driveway and protecting walkers, for example, road shoulders, pedestrian crossings, and guardrails made higher a little than the driveway can be mentioned. Furthermore, against traffic accidents occurring frequently in recent times, devices for reflecting light irradiated from a certain specific angle, such as reflector plates, are attached to road turnings. Even at night, in fog days, and at time of bad weather such as a rainfall or a snowfall, therefore, it is possible to urge drivers and walkers to confirm the safety. A large number of such devices have been devised.

However, such a reflector plate has a drawback that at night and at the time of a rainfall when more safety of traveling must be attempted, it is difficult to confirm a car running in the opposite direction, a walker, or a safety facility because reflected light is not sufficient, and at the time of a snowfall even its existence cannot be distinguished because it is buried under snow.

### SUMMARY OF THE INVENTION

In order to remove the drawback, the present invention has been made. An object of the present invention is to provide an indication apparatus of a safety facility that can make a clear distinction, for example, between a sidewalk and a driveway by using a beam going straight on, and that can make drivers certainly recognize existence of a pedestrian crossing when it is used on the pedestrian crossing.

In accordance with a first aspect of the present invention, an indication apparatus includes a light emitting system capable of emitting a beam at all times or arbitrarily, and a support capable of fixing the light emitting system vertically or in an arbitrary position, and existence of the support can be made known by light emission of the light emitting system.

In accordance with a second aspect of the present invention, the beam is formed of infrared rays the existence of which can be clearly confirmed even at the time of a snowfall or a dense fog.

In accordance with a third aspect of the present invention, the beam is emitted in a direction parallel to a road and in a position above the road that is located in height near eyes of walkers and vehicle drivers so that existence of the beam can be readily confirmed.

In accordance with a fourth aspect of the present invention, the beam is emitted so as to be turned on continuously or blinked while being interlocked with traffic signs including a signal installed on a road.

In accordance with a fifth aspect of the present invention, the beam is emitted so as to be turned on continuously or blinked while being interlocked with railroad signs including a crossing gate installed on a road.

In accordance with a sixth aspect of the present invention, a plurality of supports having the light emitting systems are installed at fixed intervals or arbitrary intervals, and consequently it is possible to make persons to notice a plane between the light emitting systems and supports. Furthermore, by emitting beams from light emitting systems of opposed supports in opposed directions, the emission distance of the beams is set equal to an arbitrary length.

In accordance with a seventh aspect of the present invention, a well-known solar system is installed on a suitable place, such as the light emitting system or the support, or a road, and means for emitting a beam by using the solar system as a power supply is included.

In accordance with an eighth of the present invention, the light emitting system is mounted on a fishing boat and used as a fish-luring device.

In the case where the present invention is used as safety indication means on a road or the like, the beam is emitted in a direction parallel to the road, and consequently a line or indication equivalent to a line or mark that indicates a road division is given in a direction parallel to the road and above the road. Even in the case where the road division cannot be recognized due to fallen snow, a line or indication that indicates a road division is given on the road with fallen snow, and consequently it is possible to make vehicle drivers and walkers visually recognize the road division.

In addition, in the case of a snowfall or a dense fog, the beam emitted from the light emitting system is subject to diffused reflection caused by snow or water particles above the road, and a light plane is formed. As a result, visual recognizability can be extremely improved. Not only when the light emission system is installed on a road, but also when the light emission system is mounted on a fishing boat, therefore, a remarkable effect is obtained.

The present invention is restricted to the configuration in which the beam is emitted in the horizontal direction. The beam may also be emitted in a vertical direction. Or there may be used a configuration in which the beam emission in the horizontal direction and the beam emission in the vertical direction are combined.

### BRIEF DESCRIPTION OF THE DRAWINGS

FIG. 1 is a schematic diagram of a beam emitting system;

FIG. 2 is a first diagram showing the case where the present invention is applied to a pedestrian crossing;

FIG. 3 is a second diagram showing the case where the present invention is applied to a pedestrian crossing;

FIG. 4 is a third diagram showing the case where the present invention is applied to a pedestrian crossing;

FIG. 5 is a first diagram showing the case where a plurality of beam emitting systems are installed side by side;

FIG. 6 is a second diagram showing the case where a plurality of beam emitting systems are installed side by side;

FIG. 7 is a diagram showing an example of use of the present invention;

FIG. 8 is a first diagram showing the case where the present invention is applied to an intersection;

FIG. 9 is a second diagram showing the case where the present invention is applied to an intersection;

FIG. 10 is a third diagram showing the case where the present invention is applied to an intersection;

FIG. 11 is a fourth diagram showing the case where the present invention is applied to an intersection; and

FIG. 12 is a diagram showing the case where the present invention is applied to a fishing boat.

### DESCRIPTION OF THE PREFERRED EMBODIMENTS

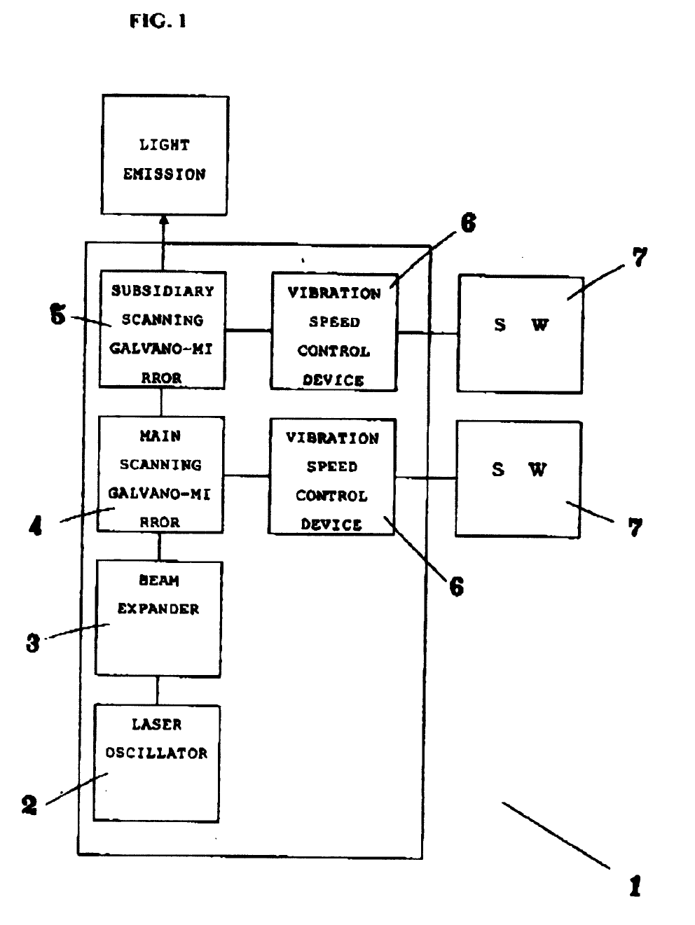

As for the configuration of a light emitting system used in the present invention, a beam using a light emitting diode or a laser is known from old. For example, in a beam emitting system 1 shown in FIG. 1, laser light supplied from an oscillator 2 is emitted from an emission window via a beam expander 3, a main galvano-mirror 4 and a subsidiary galvano-mirror 5.

As a matter of course, each of the main galvano-mirror 4 and the subsidiary galvano-mirror 5 has a switch (SW) 7, which turns on and off in order to control time or vibration in a control device 6.

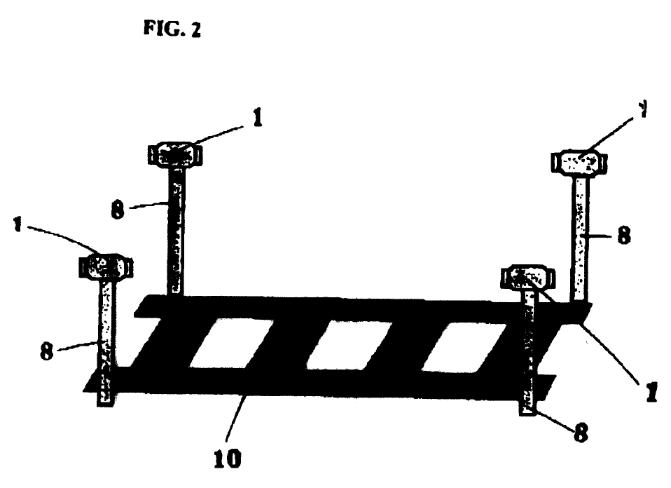

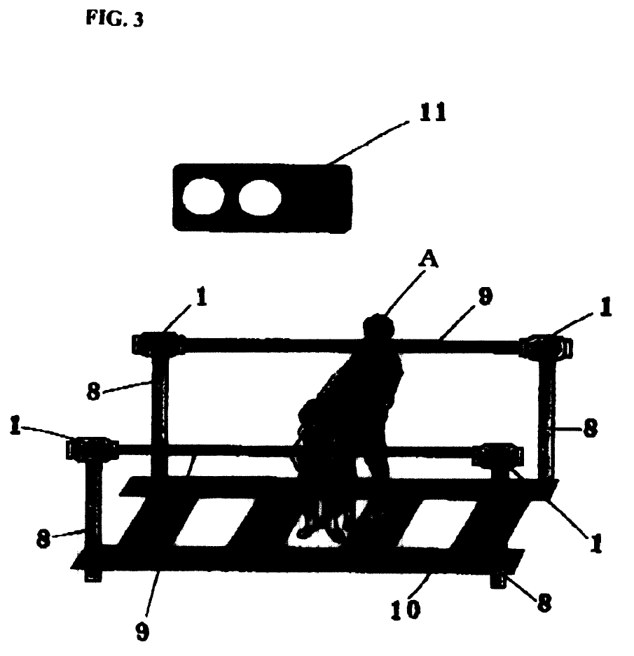

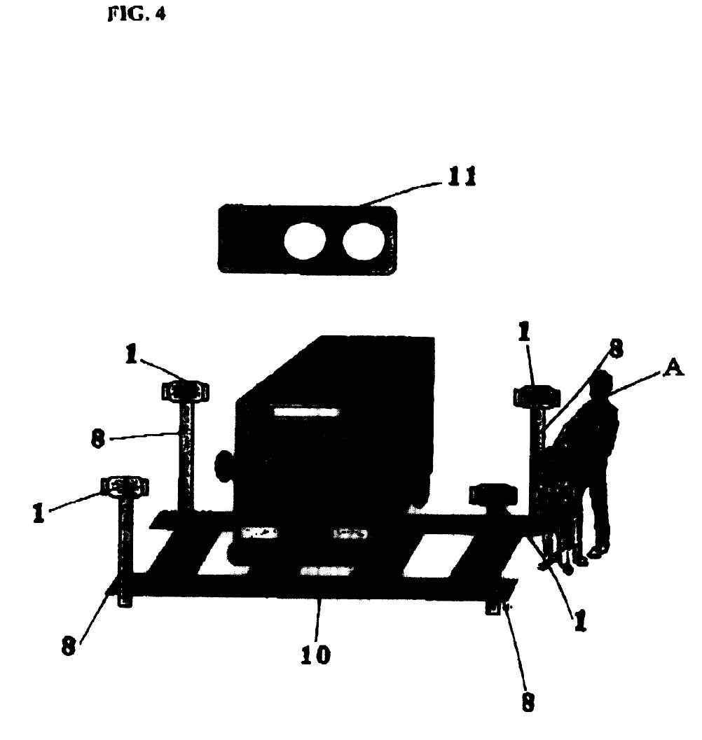

FIGS. 2 and 3 show an embodiment of the present invention on a pedestrian crossing formed in an intersection of a road or the like. Reference numeral 1 denotes a light emitting system for emitting a beam, 8 a support capable of supporting the light emitting system 1 in a suitable position of an appropriate height, 9 a beam emitted from the light emitting system 1, 10 a mark of a pedestrian crossing drawn on the road.

In FIG. 2, supports 8 are erected on four corners of the pedestrian crossing, and a light emitting system 1 is installed on the top of each of the supports 8. In this case, it is desirable to install the supports 8 disposed on the four corners in a direction perpendicular to a road. Furthermore, it is desirable that the light emitting system 1 emits a beam horizontally above the pedestrian crossing 10.

If a signal of walker side is red, the light emitting system 1 does not emit a beam.

When a signal 11 of a vehicle side is subsequently changed from green to red, i.e., “stop”, the beam 9 is emitted horizontally above the pedestrian crossing 10 from a light emitting system 1 to another light emitting system 1 disposed across the pedestrian crossing 10 on the basis of a command sent from the signal device 11. Therefore, line indication is visually recognized by a driver of a vehicle in a position of the driver's eyes. It is also possible to make a walker A recognize that the signal 11 of the vehicle side is red at the present time.

On the contrary, if the signal 11 of the walker side has changed from green to red, i.e., “stop”, then emission of the beam 9 from the light emitting system 1 is stopped on the basis of a command sent from the signal device 11. Therefore, it is possible to make the walker A recognize that the signal 11 of the vehicle side is green at the present time.

Although not especially illustrated, it is possible to make the vehicle and the walker A visually recognize the current signal state by not only emitting beams 9 in parallel to the pedestrian crossing 10 but also emitting beams 9 in parallel to the road (sidewalk).

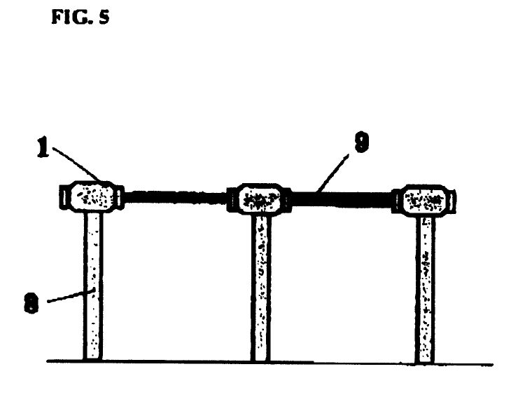

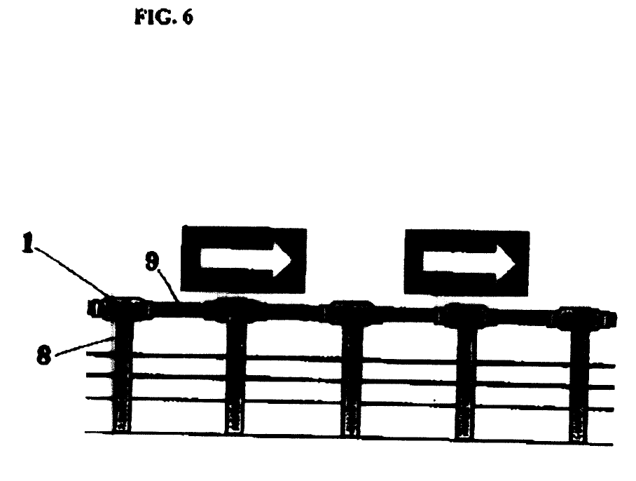

FIG. 5 shows an example of the case where a plurality of supports 8 disposed side by side are used. In this way, not only the light emitting systems of the present invention can be used for a pedestrian crossing, but also the light emitting systems of the present invention can be disposed side by side instead of, for example, a guardrail of a road. By emitting the beam 9 from the light emitting system 1 in a direction parallel to the road, a line that indicates a road division or other indication is given in a direction parallel to the road. Even in the case where the road division cannot be recognized due to, for example, fallen snow, a line that indicates a road division or other indication is given on the road with fallen snow, and consequently it is possible to make a vehicle driver or a walker visually recognize the road division.

In addition, in the case of a snowfall or a dense fog, the beam 9 emitted from the light emitting system 1 is subject to diffused reflection caused by snow or water particles above the road, and a light plane is formed. As a result, visual recognizability can be extremely improved.

FIG. 7 shows an example in which it is possible to make a vehicle driver or a walker A visually recognize the existence of a beam 9, even when snow lies on a sidewalk and a driveway and the division between them cannot be recognized, by emitting the beam 9 in parallel to a road (sidewalk).

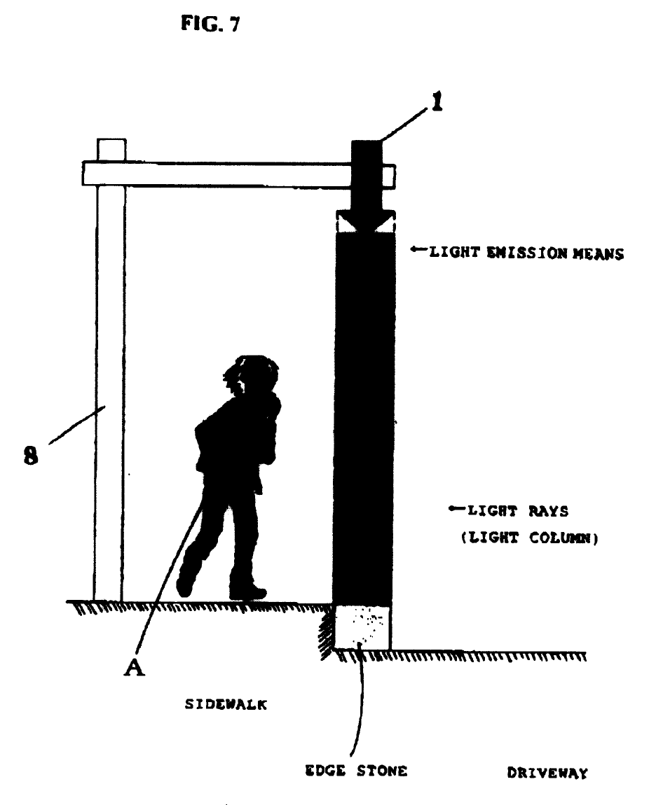

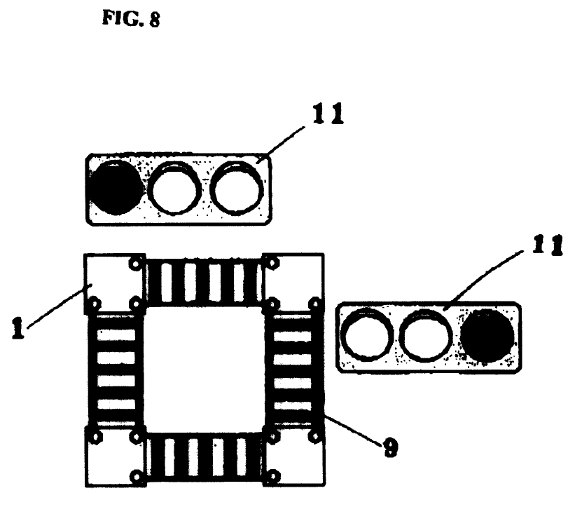

FIGS. 8 to 11 are diagrams obtained by looking down at an intersection of roads from above. In each of four corners, supports 8 for supporting light emitting systems 1 are disposed.

In FIG. 8, a signal 11 for a vehicle that travels upward in FIG. 8 is green, and a signal 11 for a vehicle that travels in a horizontal direction is red. In this case, only sidewalks that extend upward become regions where walkers can walk. Therefore, beams 9 emitted from the light emitting systems 1 are emitted in parallel to a road that extends upward. As a result, the vehicle drivers and walkers visually recognize road divisions.

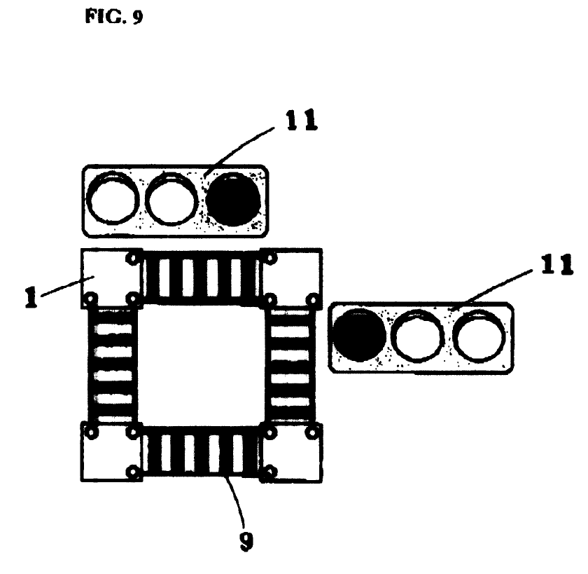

In FIG. 9, a signal 11 for a vehicle that travels upward in FIG. 9 is red, and a signal 11 for a vehicle that travels in a horizontal direction is green, in the same way. In this case, only sidewalks that extend in a horizontal direction become regions where walkers can walk. Therefore, beams 9 emitted from the light emitting systems 1 are emitted in parallel to a road that extends in the horizontal direction. As a result, the vehicle drivers and walkers visually recognize road divisions.

In the case where a signal 11 is changed from green to red via yellow, it is desirable to stop the emission of the beams 9 from the light emitting systems the moment the signal has become yellow as shown in FIG. 10 and make vehicle drivers and walkers visually recognize the signal change.

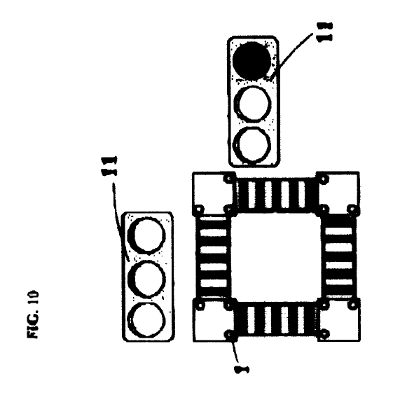

FIG. 11 shows the case of a so-called scramble intersection where all road side signals 11 in the vertical and horizontal directions indicate red. In this case, beams 9 are emitted from light emitting systems 1 disposed on the outside when seen from the intersection among the light emitting systems 1 disposed on the intersection. Thus, it is possible to indicate the whole walkable region for vehicle drivers and walkers.

The present invention has been described by taking an intersection as an example. However, embodiments of the present invention have an extremely wide range. By interlocking the light emitting systems with, for example, railroad signs including a crossing gate, it is possible not only to prevent an unforeseen traffic accident, but also to make safety for vehicle traveling and walkers more reliable.

Second Embodiment

FIG. 12 shows an embodiment using the present invention as fish-luring means by mounting the present invention systems 1 on a cuttlefish fishing boat 12 as so-called night fish-luring lights. Reference numeral 1 denotes a light emitting system, and 12 denotes a cuttlefish fishing boat generally used in the sea.

First, cuttlefish fishing will now be described briefly. The illustrated cuttlefish fishing boat 12 is supposed to be approximately 52 meters in length, 9.5 meters in width, and 463.35 tons in gross tonnage. However, the cuttlefish fishing boat 12 is not restricted to this.

Basically, cuttlefish fishing is conducted by using machines that can be subject to centralized control. One shaft passes through a box that houses a motor. An elliptical reel for winding a fishing line thereon is attached to each side of the shaft. Therefore, a cuttlefish is caught by simultaneously winding and drawing out the fishing line. Since one fishing line comes out from one machine, the machines are arranged in a row alongside the ship to conduct fishing.

In the daytime, cuttlefish stays near the sea bottom, and cuttlefish does not go up near the surface of the sea. On the contrary, when night comes, cuttlefish floats up to a depth of approximately 50 meters or the surface of the sea. Furthermore, cuttlefish has a habit of gathering around light. By utilizing these two habits, therefore, cuttlefish fishing is conducted at night by lighting the sea brilliantly.

Therefore, the light emitting systems 1 of the present invention are hung at narrow intervals on both sides of a fishing boat 12 so as to have a height of approximately 3 meters from the deck. Thereafter, light from each of the light emitting systems 1 is emitted in a direction that is nearly perpendicular to the surface of the sea. As a result, the light is emitted to the surface of the sea in order to lure cuttlefish to come toward the vicinity of the fishing boat. Owing to the light emitting systems 1 of the present invention, illuminating power of a total of approximately 250 kilowatts (corresponding to approximately 8300 fluorescent lamps) can be gathered. As a result, large catches can be obtained.

Even in the case of fishing in bad weather such as a snowfall or a dense fog, beams emitted from the light emitting systems 1 are subject to diffused reflection and a light plane is formed. As a result, visual recognizability can be extremely improved. When the light emitting systems 1 are mounted on a fishing boat, a remarkable effect is obtained.

According to the present invention, a light emitting system capable of emitting beam light at all times or arbitrarily, and a support capable of fixing the light emitting system vertically or in an arbitrary position are installed in an appropriate position as occasion demands, as heretofore described. As a result, line indication that indicates a road division is given at least on a road. Even in the case where the road division cannot be recognized due to, for example, fallen snow, a line that indicates a road division is given on the load, and consequently it is possible to make a vehicle driver or a walker visually recognize the road division.

In addition, the present invention can be used in a cuttlefish fishing boat in order to lure cuttlefish to come toward the vicinity of the fishing boat. As a result, large catches can be obtained.

What is claimed is:

1. An indication apparatus using a beam, comprising:
a light emitting system capable of emitting a beam that goes straight on, at all times or arbitrarily; and
a support capable of fixing the light emitting system in an arbitrary position in order to emit the beam in an arbitrary direction,
wherein existence of any one of various safety facilities can be made known by light emission of the light emitting system.

2. The indication apparatus using a beam according to claim 1, wherein infrared rays are used as the beam that goes straight on, in the light emitting system of claim 1.

3. The indication apparatus using a beam according to claim 1 or 2, wherein the beam of claim 1 is emitted in a direction parallel to a road.

4. The indication apparatus using a beam according to any one of claims 1 to 3, wherein the beam of claim 1 is emitted so as to be interlocked with traffic signs including a signal installed on a road.

5. The indication apparatus using a beam according to any one of claims 1 to 4, wherein the beam of claim 1 is emitted so as to be interlocked with railroad signs including a crossing gate installed on a road.

6. The indication apparatus using a beam according to any one of claims 1 to 5, wherein
a plurality of light emitting systems and supports of claim 1 are installed at suitable intervals in a predetermined position on a shoulder of a road or like,
beams are emitted from light emitting systems of opposed supports in opposed directions, and
thereby, a distance of beam emission is set equal to an arbitrary length.

7. The indication apparatus using a beam according to any one of claims 1 to 6, wherein light emission of the light emission system of claim 1 can be promoted by installing a solar system on a suitable place, such as the light emitting system or the support of claim 1, or a road.

8. The indication apparatus using a beam, wherein the light emitting system cited in anyone of claims 1 to 7 is mounted on a fishing boat and used as a fish-luring device.
